(19) United States
(12) Patent Application Publication
(10) Pub. No.: US 2020/0205388 A1
(43) Pub. Date: Jul. 2, 2020

(54) FISHING RIG STORAGE AND ORGANIZATION SYSTEM AND METHOD OF MANUFACTURE

(71) Applicant: Monty Childers, Wilmington, NC (US)

(72) Inventor: Monty Childers, Wilmington, NC (US)

(21) Appl. No.: 16/814,598

(22) Filed: Mar. 10, 2020

Related U.S. Application Data
(63) Continuation-in-part of application No. 16/127,189, filed on Sep. 10, 2018.

(51) Int. Cl. A01K 97/06

(52) U.S. Cl. CPC A01K 97/06

(57) ABSTRACT

A system may comprise a fishing storage and organization system that includes a lid having a plurality of apertures for attaching fishing equipment, such as hooks and lures. The lid may be configured to attach to a bucket, such as a standard five gallon bucket. A lid cover may be configured to fit over the top surface of the lid. The lid cover may protect the equipment from the elements while protecting a user from unintentional contact with the equipment. The lid may be constructed using a template or a mold.

### BACKGROUND

The present disclosure relates generally to storage used for tackle and other fishing equipment.

Fishing gear, such as hooks, and rigs and lures, can be difficult to safely and effectively store and deploy. For instance, exposure to the elements can rust hooks and stain fishing lures. Fishing rigs can become smelly. Moreover, pre-tied or change-out rigs can become tangled. Such fishing equipment can further be challenging to clean and organize.

### SUMMARY

According to a particular implementation, an apparatus includes a lid having a top surface and a cover configured to be removably positioned over the top surface. An attachment mechanism may be configured to removably attach the lid to a bucket. Five gallon buckets, for instance, are commonly used in fishing. A primary aperture may be present in the lid, and a plurality of secondary apertures in the lid may be positioned for attaching and hanging fishing equipment. The cover may at least partially seal the lid in the bucket from water and other corrosive elements.

The apparatus of an embodiment may further include a rib structure positioned along a top service of a lid. The attachment mechanism of an embodiment of the apparatus may comprise a lip. The primary aperture may be centered with respect to a circumference of the lid or maybe positioned another area of the lid.

The secondary apertures of an embodiment of the apparatus may be positioned around the primary aperture when centered, or at different positions relative to the primary aperture when not. The primary aperture may allow a user to insert their hand through the lid into a bucket below.

An embodiment of the apparatus may be constructed from at least one of a template or a mold. The template or mold may be reused to form multiple lids in a manner that forms the plurality of secondary apertures without cracking.

An embodiment of the apparatus made additionally include a third set of a plurality of apertures surrounding or interspersed with the plurality of second apertures. The third plurality of apertures may be staggered with respect to the second plurality of apertures. The second plurality of apertures may be differently sized than the first plurality of apertures.

The first and second plurality of apertures may include differently sized and shaped holes. That is, the first plurality apertures may have differently sized and shaped apertures than the second plurality of apertures. Additionally, the first plurality of apertures may include differently sized and shaped apertures than others of the first plurality of apertures. Similarly, the second plurality of apertures may have differently sized and shaped apertures than others of the second plurality of aperture.

A rack structure of an embodiment of the apparatus may be attached to the inside of the bucket. The rack structure may be constructed from a resilient material and may provide another surface from which equipment may be hung. For instance, the rack may hang from one an underside wall of the lid and extend to another underside wall of the lid so that it forms a horizontal hanging rack parallel to the top surface of the lid. An embodiment may further include a hanging attachment, such as a loop, configured to hang the lid on a vertical surface, such as a wall hanger.

Features and other benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### BRIEF DESCRIPTION OF THE SEVERAL VIEWS OF THE DRAWINGS

FIG. 1 shows a perspective view of an embodiment of a fishing storage and organization system that includes a lid and a lid cover.

FIG. 2 is top view of an embodiment of a storage system comprising a lid; and

FIG. 3 is flowchart of an embodiment of a method of manufacturing a fishing storage and organization system.

### DETAILED DESCRIPTION

An embodiment of the system may include a fishing storage and organization system that includes a lid having a plurality of apertures for attaching fishing equipment, such as hooks and lures. The lid may be configured to attach to a bucket, such as a standard five gallon bucket. A lid cover may be configured to fit over the top surface of the lid. The lid cover may protect the equipment from the elements while protecting a user from unintentional contact with the equipment.

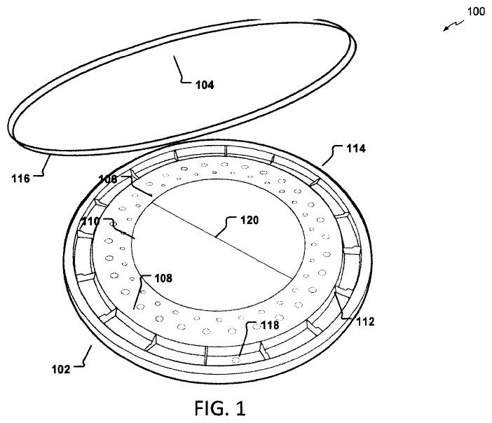

FIG. 1 shows a perspective view of an embodiment of a fishing storage and organization system 100 that includes a lid 102 and a lid cover 104. As shown in FIG. 1, the lid includes an inner ring of apertures comprising a first set of secondary apertures 106. An outer ring of apertures comprises a second set of secondary apertures 108. The apertures 106, 108 in the embodiment of the system 100 are staggered with respect to each other.

The secondary apertures 106, 108 may be differently sized to accommodate differently sized fishing hooks, lures, and other equipment. Though the secondary apertures 106, 108 in FIG. 1 are circular, the aperture of other embodiments may include different shapes, such as slots or squares. As configured in the particular embodiment of the system 100, the secondary apertures 106, 108 may be concentrically positioned around a primary aperture 110.

Rigs, lures and hooks may hook into the secondary apertures 106, 108 and hang down into a buck space through the primary aperture 110. The primary aperture 100 may be large enough to fit a hand of a user to retrieve contents stored within the bucket.

Ribs 112 may be formed around an outer diameter of the lid 102. The ribs 112 may include raised edges that form partitions around the outer diameter of the lid. The ribs 112 may thus be useful to place or hook additional equipment.

An attachment mechanism 114 (e.g., a lid lip) may snap on to the top of the bucket to form a seal. A hanging attachment 118 enable the lid 102 to be hung on a vertical surface, such as a wall hook.

Though not shown in the embodiment of the system 100 in FIG. 1, cushion material may be included near the outer diameter of the lid 102 to accommodate the attachment of hooks. Additionally, a rack structure 120 of an embodiment of the system 100 may be attached to the inside of the bucket. The rack structure 120 may be constructed from a resilient material and may provide another surface from which equipment may be hung. For instance, the rack may hang from one an underside wall of the lid 102 and extend to another underside wall of the lid 102 so that it forms a horizontal hanging rack parallel to the top surface of the lid 102.

The lid cover 104 may include a lip portion 116 that snugly fits over, snaps, or friction fits onto the sides of the lid 102. The lid cover may be formed of a pliable and resistant material, such as rubber. The lid cover of another embodiment may be rigid or constructed from plastic. The lid cover may at least partially seal the lid from the moisture.

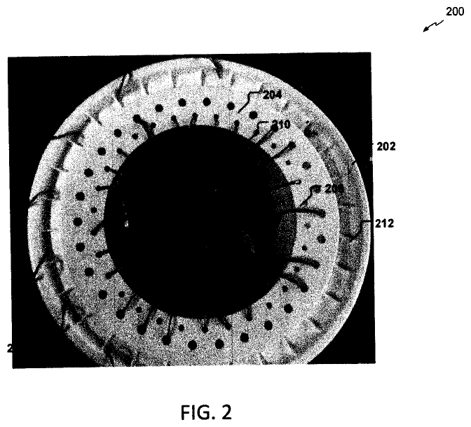

FIG. 2 is a top view of an embodiment of a storage system 200 comprising a lid 202 with secondary apertures 204 for attaching fishing equipment 206. As shown in FIG. 2, the lid 202 may be positioned on and attached to a bucket 208. The fishing equipment is shown hanging down through a primary aperture 210 into the buck 208. Ribs 212 in the lid 202 may additionally be used to attach fishing gear. Though not shown in the embodiment of the system 200 in FIG. 2, cushion material may be included near the outer diameter of the lid 202 to accommodate the attachment of hooks.

Lids of an embodiment may be constructed from a rigid or semi-rigid plastic or resin. A lid of another particular embodiment may be constructed from rubber or latex or a flexible plastic.

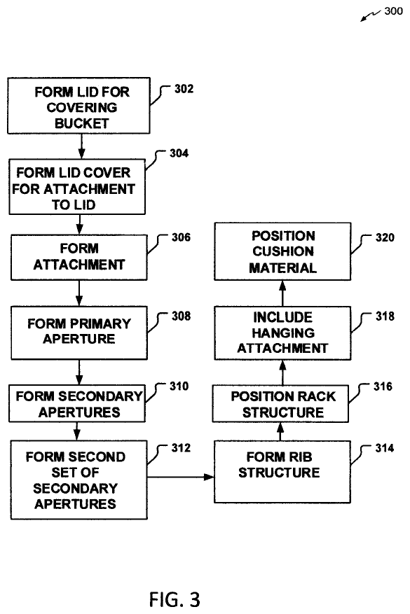

FIG. 3 is a flowchart of an embodiment of a method 300 of manufacturing a fishing storage and organization system. Such a system may be similar to those shown in FIGS. 1 and 2. Turning to the steps of the flowchart, the method 300 may include forming a lid at 302. A cover configured to removably be positioned over the lid may be formed at 304. The cover may at least partially seal the lid in the bucket from water and other corrosive elements. The cover may be constructed from a rubber or other resilient member that may stretch or deform to fit snugly over the lid.

At 306, an attachment mechanism may be formed. The attachment mechanism may be configured to removably attach the lid to a bucket. For instance, the attachment mechanism may comprise a lip.

A primary aperture may be formed in the lid at 308, and a plurality of secondary apertures may be formed at 310 in the lid for attaching fishing rigging. In one example, the primary aperture is centered with respect to a circumference of the lid. The secondary apertures are positioned around the primary aperture. According to an embodiment, a template may be used to form the primary and secondary apertures.

A second set of secondary apertures may be included at 312. The second set of secondary apertures may be staggered with respect to the first set of secondary apertures. The apertures may be different sizes and shapes.

A rib structure may be positioned or otherwise formed along the top surface of the lid at 314. Rib structures may function to compartmentalize portions of the top surface of the lid.

At 316, a rack structure to be attached or otherwise positioned within an interior portion of the lid. According to a particular embodiment, the rack structure is constructed from resilient material.

A hanging attachment may be included at 318. The hanging attachment may be configured to hang the lid on a vertical surface, and cushion material may be positioned along a top surface of the lid at 320.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow

What is claimed is:

1. An apparatus comprising:
a lid having a top surface;
a cover configured to be removably positioned over the top surface;
an attachment mechanism configured to removably attach the lid to a bucket;
a primary aperture in the lid; and
a plurality of secondary apertures in the lid for attaching fishing rigging.

2. The apparatus of claim 1, further comprising a rib structure positioned along the top surface of the lid.

3. The apparatus of claim 1, wherein the attachment mechanism comprises a lip.

4. The apparatus of claim 1, wherein the primary aperture is centered with respect to a circumference of the lid.

5. The apparatus of claim 4, wherein the secondary apertures are positioned around the primary aperture.

6. The apparatus of claim 1, further comprising a rack structure to be attached within an interior portion of the lid.

7. The apparatus of claim 6, wherein the rack structure is constructed from resilient material.

8. The apparatus of claim 1, further comprising a hanging attachment configured to hang the lid on a vertical surface.

9. The apparatus of claim 1, further comprising at least one of a template and a mold used to form the plurality of secondary apertures.

10. The apparatus of claim 1, wherein the cover at least partially seals the lid and bucket from water.

11. The apparatus of claim 1, further comprising a second plurality of secondary apertures.

12. The apparatus of claim 11, wherein the second plurality is staggered with respect to the first plurality of apertures.

13. The apparatus of claim 11, wherein the second plurality is different sized than the first plurality.

14. The apparatus of claim 1, further comprising a cushion material positioned along the top surface of the lid.

15. A method of manufacturing a container lid, the method comprising:
forming a lid having a top surface;
forming a cover configured to be removably positioned over the top surface;
an attachment mechanism configured to removably attach the lid to a bucket;
a primary aperture in the lid; and
forming a plurality of secondary apertures in the lid for attaching fishing rigging.

16. The method of claim 15, further comprising using at least one of a template and a mold used to form the plurality of secondary apertures.

17. The method of claim 15, further comprising centering the primary aperture with respect to a circumference of the lid.

18. The method of claim 15, further comprising positioning the secondary apertures around the primary aperture.

19. The method of claim 15, further comprising including a rack structure within a surface of the lid.

20. The method of claim 15, further comprising include a second plurality of secondary apertures, wherein the second plurality of secondary apertures is staggered with respect to the first plurality of apertures.
